(19) United States
(12) Patent Application Publication
(10) Pub. No.: US 2009/0230593 A1
(43) Pub. Date: Sep. 17, 2009

(54) METHOD FOR FORMING DYNAMIC PRESSURE GENERATING GROOVES

(75) Inventors: Fuminori Satoji, Mie (JP); Kenji Ito, Mie (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NTN CORPORATION, Osaka-shi, Osaka (JP)

(21) Appl. No.: 12/065,828

(22) PCT Filed: Aug. 24, 2006
(86) PCT No.: PCT/JP2006/316591

§ 371 Date: Mar. 5, 2008

(30) Foreign Application Priority Data
Sep. 5, 2005 (JP) 2005-256907

(51) Int. Cl. B29C 45/17

(52) U.S. Cl. 264/443

(57) ABSTRACT

High-precision, low-cost molding of dynamic pressure generating grooves is made possible.

An ultrasonic generating device 20 is connected to an injection mold 10. The dynamic pressure generating grooves are molded by means of radial dynamic pressure generating groove forming parts 16 and a thrust dynamic pressure generating groove forming part 17 provided in the injection mold 10, with ultrasonic vibration generated by the ultrasonic generating device 20 being applied to the injection mold 10 during the injection molding.

### TECHNICAL FIELD

The present invention relates to a method for forming dynamic pressure generating grooves that generate fluid dynamic pressure in bearing gaps.

### BACKGROUND ART

Fluid dynamic bearing devices are widely used as the bearing of spindle motors that are mounted in information equipment such as HDDs or other magnetic disk devices, CD-ROMs, CD-R/RWs, DVD-ROM/RAMs or other optical disk devices, MDs, MOs or other magnetic optical disk devices, of polygon scanner motors mounted in laser beam printers (LBP) or the like, of fan motors mounted in personal computers (PC), or of small motors mounted in electrical equipment such as axial fans.

High rotation precision, high speed, and low noise are the requirements for the various types of motors listed above. One of the constituent elements of the motor that determines these performance requirements is the bearing that supports the spindle, and the fluid dynamic bearing device which is excellent in the above characteristics is commonly used in recent years for this sort of bearing application.

The fluid dynamic bearing device is provided with a radial bearing part and a thrust bearing part that support a rotating member (such as a shaft member) in a radial direction and in a thrust direction, respectively. A dynamic bearing that supports a shaft member in a non-contact manner is used for the radial bearing part. On the other hand, for the thrust bearing part, the dynamic bearing that supports the shaft member in a non-contact manner is used in some cases, and a so-called pivot bearing that supports the component in contact therewith is used in other cases. When both of the radial bearing part and the thrust bearing part are dynamic bearings, either one of the two opposite surfaces separated by a radial bearing gap and thrust bearing gap is provided with dynamic pressure generating grooves as means for generating dynamic pressure.

Now, with the recent rapid technical advances in performances of information equipment, efforts are being focused on improving rotation precision of the fluid dynamic bearing device. The price, on the other hand, of information equipment is going down, which makes the need to reduce costs of the fluid dynamic bearing device more acute. To meet such need, attempts have been made to convert pricey metal parts of the constituent elements of fluid dynamic bearing device to resin parts. To give one example of such attempts, there is known a method in which a bearing member made of resin, which can accommodate a shaft member inside, is injection-molded, with dynamic pressure generating grooves being molded on the inner circumferential surface of this bearing member so as to generate fluid dynamic pressure in the radial bearing gap (see, for example, Patent Document 1).

Patent Document 1: Japanese Patent Application Laid-Open No. Hei 9-222118

### DISCLOSURE OF THE INVENTION

### Problems to be Solved by the Invention

The dynamic pressure generating grooves need to be molded with a high molding precision in order of microns to enable accurate control of rotation precision of the fluid dynamic bearing device. Therefore, when molding such dynamic pressure generating grooves as in the above-mentioned Patent Document 1, it is crucial to fill a resin material completely to every parts of the injection mold, in particular, to the part that will form the dynamic pressure generating grooves (hereinafter referred to as “dynamic pressure generating groove forming part”) to achieve dynamic pressure generating grooves with high precision. However, one of the characteristics of injection molding is that the injection mold temperature is set lower than that of the resin material, because of which cured coat of resin material (so-called skin layer) is formed near the interface between the mold and the resin material during the injection of the resin material. Skin layer formation increases fluid resistance, because of which the resin material may not completely fill particularly to the minute pattern of dynamic pressure generating groove forming part and the dynamic pressure generating grooves thus formed may fail to meet the precision requirements. Commonly used techniques to avoid such situation are to raise the temperature of the mold or resin material, or to increase the injection pressure, but these techniques are not preferable because of possible adverse effects on the cycle time or molding precision.

When releasing (separating) the molded piece from the injection mold, generally, the molded piece is pushed out and separated from the injection mold using an ejector device. Resin material, however, when injection molded, tends to adhere to the wall of the injection mold (cavity), and so an attempt to separate the molded piece using only the ejector device may cause damage on the molded surface. The use of such technique, therefore, is not preferable for molded pieces such as bearing members, with parts (dynamic pressure generating grooves) that need to meet high precision requirements. Therefore, there is known a method to facilitate release from the mold, for example, by applying a release agent on the injection mold. This, however, requires a process step of applying the release agent, and other process steps, for example, of removing the release agent after the molded piece has been released, and such increase in the number of process steps will drive up the manufacturing cost.

Accordingly, an object of the present invention is to provide a method that enables high-precision and low-cost molding of dynamic pressure generating grooves.

Another object of the present invention is to provide a method that enables easy release of injection-molded pieces formed with dynamic pressure generating grooves from the injection mold.

### Means for Solving the Problems

To achieve the above objects, the present invention provides a method for forming dynamic pressure generating grooves characterized in that ultrasonic vibration is applied to an injection mold when molding dynamic pressure generating grooves using dynamic pressure generating groove forming parts provided in the injection mold.

Of a series of process steps included in the injection molding, during the injection of material, for example, the ultrasonic vibration is applied to the injection mold, so that the material is heated again instantaneously and kept molten at the contact area between the mold and the material. This prevents or delays formation of a skin layer at the contact area, which was a conventional problem during the injection of the material. Accordingly, the present invention enables accurate molding of dynamic pressure generating grooves, as the fillability of the material into every parts of the cavity, particularly to the dynamic pressure generating groove forming part is improved, without inviting a situation in which the cycle time is increased or molding precision is lowered due to an increase in the temperature of the mold or the material. The ultrasonic vibration may also be applied to the gate through which the material is injected, whereby the flow resistance at the gate is reduced and the material injection time is shortened, leading to a reduction in the cycle time.

The present invention further provides a method for forming dynamic pressure generating grooves characterized in that ultrasonic vibration is applied to the injection mold when releasing a molded piece from the injection mold after the dynamic pressure generating grooves have been molded by the dynamic pressure generating groove forming part provided in the injection mold.

The ultrasonic vibration is applied to the injection mold when releasing the molded piece from the injection mold, when, for example, the mold is opened after the cooling and curing, so that the adhesion between the mold and the molded piece is loosened at the contact area, i.e., releasability is improved. Thus easy release of the molded piece from the mold is made possible, without deteriorating the surface precision of the part formed with the dynamic pressure generating grooves, which was a problem involved in the conventional techniques. Moreover, since there is no need of applying and removing any release agent, there will be no manufacturing cost increase due to an increase in the process steps.

The injection mold to which the present invention is applicable can be in any form as long as it is designed for molding a component with dynamic pressure generating grooves. For example, the injection mold may be the one for forming a fixed member, typically a bearing member, having one surface that will face the bearing gap, or the one for forming a rotating member, typically a shaft member, having the other surface that will face the bearing gap. The present invention is applicable not only to resin materials but also can be applied favorably to other injection materials such as low melting point metal materials, or mixtures of metal powder and resin binder or of ceramic and resin binder.

### EFFECT OF THE INVENTION

As described above, according to the present invention, dynamic pressure generating grooves can be molded highly precisely and at low cost. Also, according to the present invention, the molded pieces are easily released from the mold without damaging the dynamic pressure generating grooves.

### BEST MODE FOR CARRYING OUT THE INVENTION

Embodiments of the present invention will be hereinafter described with reference to the drawings.

FIG. 1 shows one example of a molding apparatus used for molding dynamic pressure generating grooves that generate fluid dynamic pressure in bearing gaps. Here is given a schematic illustration of an injection molding apparatus used for molding dynamic pressure generating grooves on the inner circumferential surface 8a and on one end face (lower end face 8b in FIG. 4) of a bearing member 8 (see FIG. 4), which is a resin injection-molded fixed member.

The injection molding apparatus includes, as major constituent elements, an injection mold 10 consisting of a fixed mold half 11 held by suitable means (not shown) and a movable mold half 12 set coaxially with the fixed mold half 11, and an ultrasonic generating device 20 that applies ultrasonic vibration to the injection mold 10.

The injection mold 10 is made of a metal material having excellent ultrasonic vibration transmission characteristics as well as high fatigue strength against vibration, for example a titanium alloy, an aluminum alloy, stainless steel, or the like. The fixed mold half 11 of the injection mold 10 is provided with a gate 13, through which a resin material supplied from a nozzle or the like (not shown) is injected into the cavity 14. The gate 13 can be of any shape as long as the injected material can be filled uniformly in the cavity 14, and film gates, point gates (including multi-point gates), and disk gates are selectable.

The movable mold half 12 is provided with a shaft part (core) 15. On the outer circumferential surface of the core 15, radial dynamic pressure generating groove forming parts 16 are formed at two axially spaced-apart locations, the parts conforming to the shape of the dynamic pressure generating grooves to be formed on the inner circumferential surface 8a of the bearing member 8.

FIG. 3 is a more specific representation of one embodiment of the core 15. The radial dynamic pressure generating groove forming parts 16 are shaped such that their concavo-convex pattern is inverted with respect to the dynamic pressure generating grooves to be formed on the inner circumferential surface of the bearing member 8, and the pattern includes, for example, multiple herringbone-aligned concaves 16b and convexes 16a dividing the concaves 16b. In this embodiment, the outer circumferential surface of the core 15 forms the convexes 16a, i.e., the radial dynamic pressure generating groove forming parts 16 are provided by forming the concaves 16b by means of, for example, rolling, cutting, or etching. Conversely, the outer circumferential surface of the core 15 can form the concaves 16b, with the convexes 16a being provided by, for example, printing. During the molding, the convexes 16a form the dynamic pressure generating grooves, while the concaves 16b form the parts dividing the dynamic pressure generating grooves. While the drawing shows the example with an emphasis for ease of understanding, the difference in level between the convexes 16a and concaves 16b are approximately 2 to 5 μm. It should also be noted that while the drawing shows one example in which the concaves 16b are formed in a herringbone pattern, they can be formed in a spiral pattern to conform to the dynamic pressure generating groove shape.

On the bottom face on the radially inner side of the cavity 14, a thrust dynamic pressure generating groove forming part 17 is formed that conforms to the shape of the dynamic pressure generating grooves to be formed on one end face of the bearing member 8. Similarly to the radial dynamic pressure generating groove forming parts 16, the thrust dynamic pressure generating groove forming part 17 is shaped such that their concavo-convex pattern is inverted with respect to the dynamic pressure generating grooves to be formed on one end face of the bearing member 8. Although not illustrated in detail, the pattern includes, for example, multiple spirally aligned convexes 17a and concaves 17b dividing the convexes 17a. In this embodiment, the convexes 17a form the bottom face on the radially inner side of the cavity 14, and the concaves 17b are provided by means of, for example, cutting, or etching, as with the case mentioned above. It goes without saying that the thrust dynamic pressure generating groove forming part 17 can be formed in other patterns to conform to a desired dynamic pressure generating groove shape, such as a herringbone pattern or radial groove pattern.

The injection mold 10 is provided with a guide mechanism to enable positioning of the fixed mold half 11 and the movable mold half 12 relative to each other when the mold is clamped. Various known means can be selected for this guide mechanism as long as it enables positioning of both mold halves relative to each other. In the present embodiment, the fixed mold half 11 has guide holes 18 having a trapezoidal cross section on the surface that makes contact with the movable mold half 12, and the movable mold half 12 in return has guide pins 19 on the surface that makes contact with the fixed mold half 11, which pins conform to the shape of the guide holes 18 and fit in the guide holes 18 when the mold is clamped.

One or a plurality of ultrasonic generating device 20 is connected to the movable mold half 12 in order to apply ultrasonic vibration to the injection mold 10. In the present embodiment, the ultrasonic generating device 20 is made up of a transducer 22, an ultrasonic oscillator 21 connected to the transducer 22, and a horn 23 fixed at one end thereof to the transducer 22. In the present embodiment, the horn 23 is abutted on the surface of the movable mold half 20 at the end opposite from the side that is fixed to the transducer 22, so that the ultrasonic generating device 20 is connected to the injection mold 10, but the horn 23 may be embedded in a certain location of at least one of the movable mold half 12 and the fixed mold half 11.

The ultrasonic oscillator 21 applies ultrasound with a predetermined frequency and amplitude (electrical signal) to the transducer 22. The transducer 22 includes a piezoelectric element so that it converts the ultrasound applied from the ultrasonic oscillator 21 into mechanical vibration (ultrasonic vibration). The horn 23 is given for efficient application of the ultrasonic vibration generated by the transducer 22 to the injection mold 10, and can be changed as required in accordance with the shape of the injection mold 10. As with the injection mold 10, the horn 23 is made of a metal material that has excellent ultrasonic vibration transmission characteristics and high fatigue strength against ultrasonic vibration, such as a titanium alloy, an aluminum alloy, or stainless steel.

In the injection molding apparatus having the above configuration, when the movable mold half 12 is moved up and clamped, the guide pins 19 formed on the movable mold half 12 fit into the guide holes 18 formed on the fixed mold half 11 as shown in FIG. 2, whereby the movable mold half 12 and the fixed mold half 11 are positioned relative to each other. After the mold clamping, a molten resin material (indicated as arrows in FIG. 2) supplied from a nozzle (not shown) is injected through the gate 13 into the cavity 14.

Any resin material can be used as long as it is injection-moldable, and amorphous resins and crystalline resins are both usable. Usable amorphous resins include, for example, polysulfone (PSU), polyethersulfone (PES), polyphenylsulfone (PPSU), polyetherimide (PEI) and the like. Usable crystalline resins include, for example, liquid crystalline polymer (LCP), polyphenylenesulfide (PPS), polyetheretherketone (PEEK), polybutylene terephthalate (PBT) and the like. Various fillers such as reinforcements (fibrous, powdery, or any other forms), lubricants, conductive materials and others can be admixed in these resin materials listed as examples. One type of filler may be used alone, or two or more types of fillers may be used together.

When the resin material is injected into the cavity 14, the ultrasound generated by the ultrasonic oscillator 21 and converted into ultrasonic vibration through the transducer 22 and the horn 23 is applied to the injection mold 10. The ultrasonic vibration may be applied continuously from the start to the completion of the injection, or, it may be applied intermittently. It is applied at a timing preprogrammed in consideration of injection pressure, mold temperature, and other factors. The frequency of the applied ultrasonic vibration can be selected from the range of 10 KHz to 10 MHz. If, however, the frequency is too high, the resin material may be heated too much which will lead to problems such as increased cure time. Accordingly, the frequency should preferably be selected from the range of 10 KHz to 100 KHz. The amplitude of the applied ultrasonic vibration is selected suitably in accordance with the material of the injection mold 10 and the horn 23. To achieve maximum effective use of the effects of ultrasonic vibration, it is preferable to apply ultrasonic vibration such that the amplitude peaks of vibration generally correspond to the dimensions of the dynamic pressure generating groove forming parts 16 and 17 and the gate 13 (in the radial direction).

When the injection of resin material is complete, ultrasonic sound application is paused. The mold clamping force is lowered, and the resin material is cooled down and set in this state. After the setting, the movable mold half 12 is lowered to open the mold, so that the molded piece (bearing member 8) fixedly attached to the movable mold half 12 is obtained. Then, while ultrasonic vibration is applied to the injection mold 10 (movable mold half 12) similarly to when the resin is injected, the molded piece is pushed out by an ejector device or the like which is not shown (for example, an ejector pin). This separates the molded piece from the movable mold half 12, and thus the bearing member 8 made of resin having dynamic pressure generating grooves on the inner circumferential surface and on one end face is obtained. Note, application of ultrasonic vibration at this time with the same frequency and amplitude as those during the injection may lead to excessive heat generation and melting of the resin material near the molded surface, which may deteriorate releasability from the mold, and therefore it is preferable to apply ultrasonic vibration with a lower frequency and amplitude than those during the injection.

By applying ultrasonic vibration to the injection mold 10 (movable mold half 12) when injecting a resin material as in the present invention, the resin material is instantly re-heated and kept molten at the contact area between the injection mold 10 and the resin material. This prevents or delays formation of a skin layer, which resulted from a temperature difference between the resin material and the injection mold 10 and deteriorated the fillability of the resin material being filled, in particular, into the radial dynamic pressure generating groove forming parts 16 and the thrust dynamic pressure generating groove forming part 17. Thus, fillability of the resin material being filled into each of the dynamic pressure generating groove forming parts 16 and 17 is improved, whereby accurate molding of dynamic pressure generating grooves is made possible. Furthermore, the effect of the ultrasonic vibration on the gate 13 during the injection of the resin material reduces flow resistance of the resin material at the gate 13, whereby the injection time can also be shortened.

Methods adopted conventionally to improve the fluidity (fillability) of the resin material included, for example, making higher the temperature of the mold or resin material, or increasing the injection pressure. However, raising the mold temperature would increase the cooling/curing time, and raising the material temperature or injection pressure would increase shrinkage (sink marks) when cooled and cured, and so both led to deterioration of molding precision. In contrast, according to the present invention, good fillability is achieved without adopting any of these methods, whereby a reduction in the production cost is achieved owing to reduced cycle time, and the molding precision is made higher.

When a resin material is injection molded, the resin material tends to adhere to the cavity 14. In the present embodiment, in particular, in which dynamic pressure generating grooves are molded on the inner circumferential surface of the bearing member 8 diagonally to the axial direction, it was difficult to remove the molded piece from the mold without damaging the dynamic pressure generating grooves because of the concavo-convex engagement that acts in the removal direction between the molded piece and the radial dynamic pressure generating groove forming parts 16. In this embodiment, however, by applying ultrasonic vibration to the injection mold 10 when removing the molded piece (bearing member 8) from the injection mold 10, the adhesion between the radial dynamic pressure generating groove forming parts 16 and the molded piece at the interface is loosened, whereby the releasability is remarkably improved. Thus dynamic pressure generating grooves with high precision are formed without any damage to the groove shape. Furthermore, according to the present invention, since there is no need to apply a release agent for improving releasability and to remove the same, the number of process steps is reduced, which can reduce the production cost.

The bearing member 8 thus formed is mounted as one constituent element and used in the fluid dynamic bearing device.

FIG. 4 illustrates specifically one example of a fluid dynamic bearing device 1 incorporating the bearing member 8 formed through the process described above. The dynamic bearing device 1 includes, as major constituent elements, the bearing member 8, a shaft member 2 inserted into the bearing member 8, a housing 7 accommodating the bearing member 8, a seal member 9 sealing one open end of the housing 7, and a lid member 6 sealing the other open end of the housing 7. In the present embodiment, the bearing component constitutes the fixed member, whereas the axial component 2 constitutes the rotating member. The seal member 9 side is described as the upper side and the lid member 6 side as the lower side in the following description for ease of explanation.

The shaft member 2, or the rotating member, is made of a metal material such as stainless steel or the like, and is composed of a shaft part 2a and a flange part 2b which can either be integral with the shaft part 2a or a separate component and extending radially outwards from the shaft part 2a. In the present embodiment, the outer circumferential surface 2a1 of the shaft part 2a is formed to have a true circle cross section, without any concavo-convex pattern such as dynamic pressure generating grooves. Both end faces 2b1 and 2b2 of the flange part 2b are also formed to have a flat surface without any concavo-convex pattern such as dynamic pressure generating grooves.

The bearing member 8, or the fixed member, is formed generally cylindrical by resin injection molding as described above, and on the inner circumferential surface 8a of this bearing member 8, for example, two, upper and lower, axially spaced-apart regions which will form the radial bearing surfaces A of the first radial bearing part R1 and the second radial bearing part R2 are provided as shown in FIG. 5A. Multiple herringbone-aligned dynamic pressure generating grooves Aa have been molded in both of the radial bearing surfaces A. The dynamic pressure generating grooves Aa on the axially upper side are formed asymmetric with respect to the axial center m (axial center of the region between the upper and lower diagonal grooves), with the upper region above the axial center m having a larger axial dimension X1 than the axial dimension X2 of the lower region. Therefore, when the bearing device is in operation (when the shaft member 2 is rotated), the upper dynamic pressure generating grooves Aa will generate a relatively larger force to draw lubrication oil (pumping force) than that of the lower, symmetric dynamic pressure generating grooves Aa.

The partial annular region of the lower end face 8b of the bearing member 8 forms the thrust bearing surface B of the first thrust bearing part T1. Multiple spirally aligned dynamic pressure generating grooves Ba shown in FIG. 5B have been molded in this thrust bearing surface B.

The bearing member 8 has a stepped part 8e at its lower end opening, and the lid member 6 made of metal is arranged on the radially inner side of the stepped part 8e, the lid member 6 closing the lower end opening of the bearing member 8. This lid member 6 is configured to include a cylindrical side part 6b and a bottom part 6a integrally provided to close the lower end opening of the side part 6b, so that it is cylindrical and has a bottom. The partial annular region on the upper end face 6a1 of the bottom part 6a forms the trust bearing surface C of the second thrust bearing part T2, where, for example, multiple spirally aligned dynamic pressure generating grooves have been formed (not shown). Not to mention, the dynamic pressure generating groove shape can be a herringbone pattern or a radial pattern.

The lid member 6 having the above configuration is fixed to the stepped part 8e of the bearing member 8 by suitable means such as adhesion. In this case, the flange part 2b of the shaft member 2 is accommodated in the space formed between the lower end face 8b of the bearing member 8 and the upper end face 6a1 of the bottom part 6a of the lid member 6. The upper end face 6b1 of the side part 6b of the lid member 6 is abutted on the lower end face 8b of the bearing member 8 so that the thrust bearing gap is accurately controlled.

The bearing member 8 also includes a stepped part 8d at the upper end opening, and the annular seal member 9 made of a metal material or resin composition is arranged on the radially inner side of this stepped part 8d. The seal member 9 is fixed to the inner circumferential surface of the stepped part 8d by suitable means such as adhesion. The inner space of the fluid dynamic bearing device 1 sealed with the seal member 9 is filled with lubricating fluid such as, for example, lubrication oil. The inner circumferential surface 9a of the seal member 9 has a tapered surface upwardly increasing in diameter and facing the outer circumferential surface 2a1 of the shaft part 2a via a predetermined sealing space S. The tapered surface need only be formed on either one of the opposite surfaces separated by the sealing space S, i.e., it can be formed on the outer circumferential surface 2a1 of the shaft part 2a. In that case, it can function as a centrifugal seal that uses rotation of the shaft member 2. The sealing space S also has a function of absorbing volume changes of lubrication oil caused by temperature changes (buffer function), so that the oil surface of the lubrication oil always remains within the sealing space S irrespective of the operation state of the bearing device (whether it is paused or in operation).

In the fluid dynamic bearing device 1 having the above configuration, during relative rotation between the shaft member 2 and the bearing member 8 (the shaft member 2 actually rotating in the present embodiment), the respective two, upper and lower, spaced-apart regions on the inner circumferential surface 8a of the bearing member 8, which will form the radial bearing surfaces A, face the outer circumferential surface of the shaft part 2a of the shaft member 2 via a radial bearing clearance. As the shaft member 2 rotates, the dynamic pressure generating grooves Aa formed on the radial bearing surfaces A create dynamic pressure in the lubrication oil that fills the radial bearing gap, and this pressure radially and rotatably supports the shaft member 2 in a non-contact manner. Thus the first radial bearing part R1 and the second radial bearing part R2 are formed, which radially and rotatably support the shaft member 2 in a non-contact manner.

During rotation of the shaft member 2, the thrust bearing surface B formed on the lower end face 8b of the bearing component 8 faces the upper end face 2b1 of the flange part 2b via a thrust bearing clearance. As the shaft member 2 rotates, the dynamic pressure generating grooves Ba formed on the thrust bearing surface B create dynamic pressure in the lubrication oil that fills the thrust bearing gap, and this pressure rotatably supports the shaft member 2 in the thrust direction in a non-contact manner. Thus the first thrust bearing part T1 is formed, which rotatably supports the shaft member 2 in the thrust direction in a non-contact manner. Similarly, during rotation of the shaft member 2, the thrust bearing surface C formed on the upper end face 6a1 of the lid member 6 faces the lower end face 2b2 of the flange part 2b via a thrust bearing gap. As the shaft member 2 rotates, the dynamic pressure generating grooves formed on the thrust bearing surface C create dynamic pressure in the lubrication oil that fills the thrust bearing gap, and this pressure rotatably supports the shaft member 2 in the thrust direction in a non-contact manner. Thus the second thrust bearing part T2 is formed, which rotatably supports the shaft member 2 in the thrust direction in a non-contact manner.

During the operation of the fluid dynamic bearing device 1, sometimes, a negative pressure is created in some partial regions of the lubrication oil that fills the inner space. Such negative pressure may cause air bubble formation, lubrication oil leakage, or other problems such as, typically, vibration generation. The present embodiment therefore adopts a configuration to prevent creation of local negative pressure, in which the dynamic pressure generating groove pattern of the upper side radial bearing surface A is axially asymmetric as mentioned above so as to apply an axially downward pumping force to the lubrication oil that fills the radial gap (radial bearing gap) between the outer circumferential surface 2a1 of the shaft part 2a and the inner circumferential surface 8a of the bearing member 8. In addition to this, a circulation path 4 is provided to return the pushed-down lubrication oil to the upper end of the radial gap so as to cause forced circulation of the lubrication oil inside the fluid dynamic bearing device 1.

The circulation path 4 illustrated in FIG. 4 is made up of an axial flow path 4a that communicates the upper and lower end faces 8b and 8c of the bearing member 8, a first radial flow path 4b formed between the lower end face 9b of the seal member 9 and the upper end face 8c of the bearing member 8, and a second radial flow path 4c formed between the upper end face 6b1 of the lid member 6 and the lower end face 8b of the bearing member 8. Although the drawing shows one example in which the first radial path 4b is formed in the lower end face 9b of the seal member 9 and the second radial path 4c is formed in the upper end face 6b1 of the lid member 6, these paths 4b and 4c may be formed in respective opposite surfaces (upper and lower end faces 8c and 8b of the bearing member). By thus providing such circulation path 4, the lubrication oil circulates inside the fluid dynamic bearing device 1 during its operation through the route connecting the thrust bearing gap, second radial flow path 4c, axial flow path 4a, first radial flow path 4b, and upper end of the radial gap. This prevents formation of local negative pressure in the lubrication oil in the inner space of the bearing device.

Although one embodiment of the present invention has been described above, the configuration of the present invention is applicable not only to the bearing member which is a fixed member but also can be favorably employed for providing dynamic pressure generating grooves on a rotating member (for example, the shaft member or a disk hub). Hereinafter, a description will be given only with respect to the components or parts on which the dynamic pressure generating grooves are molded, and a detailed description of other components or parts will be omitted, with the same reference numerals as above being given to these components or parts.

FIG. 6 illustrates one example of a rotating member formed using the system of the present invention. The shaft member 2, which is the rotating member, has radial bearing surfaces A on its outer circumferential surface, and dynamic pressure generating grooves Aa are provided in these radial bearing surfaces A. In the illustrated example, the shaft member 2 has a hybrid structure consisting of a resin part 24 and a metal part 25, with the core part of the shaft part 2a and the flange part 2b being the metal part 25 and the outer circumferential surface of the shaft part 2a being the resin part 24.

This shaft member 2 is formed by injection molding (insert molding), with the metal part 25 being the insert in the resin part 24. The ultrasonic vibration described above is applied to the injection mold during the injection molding of the resin part 24, so that the dynamic pressure generating grooves Aa are molded highly precisely. Although not shown, the system of the present invention can be applied equally if the resin part 24 includes a flange part 2b, with thrust bearing surfaces B and C molded on this flange part 2b.

FIG. 7 illustrates another embodiment of a dynamic bearing device 1 having dynamic pressure generating grooves provided on the rotating member. The second thrust bearing part T2 in this dynamic bearing device 1 is formed between the thrust bearing surface C formed on the lower end face 7a1 of a rotor (disk hub) 7, which forms the rotating member, and the upper end face 8c of the bearing member 8, which is a fixed member.

The rotating member is integrally formed by injection molding (insert molding), with the shaft member 2 being the insert in the disk hub 7. The ultrasonic vibration is applied to the injection mold during the injection molding, so that the dynamic pressure generating grooves of the thrust bearing surface C are molded highly precisely.

In the embodiments described above are shown only examples of typical configurations of fixed members and rotating members. The configuration of the present invention can also be favorably applied to other parts, for example, when providing dynamic pressure generating grooves on the lid member or seal member, by molding.

Furthermore, although the description above has been in relation to injection molding that uses resins as the material to be injected, but the material can be anything as long as it is injection-moldable and should not be limited to resin materials. The configuration of the present invention is also favorably applicable to injection molding that uses low melting point metals such as magnesium alloy, mixture of metal powder and binder, or of ceramic and binder.

FIG. 8 is a conceptual representation of one example of a spindle motor for use in information equipment, in which the fluid dynamic bearing device 1 shown in FIG. 4 is mounted. This spindle motor for information equipment is used for example in a disk drive device such as HDDs, and includes the dynamic bearing device 1, a disk hub 33 attached to the shaft member 2 of the fluid dynamic bearing device 1, a stator coil 34 and a rotor magnet 35 opposite each other via a radial gap, and a bracket 36. The stator coil 34 is attached on the outer side of the bracket 36, while the rotor magnet 35 is attached on the inner side of the disk hub 33. The disk hub 33 holds one or a plurality of disks D such as magnetic disk on its periphery. The housing 7 of the fluid dynamic bearing device 1 is mounted on the inner side of the bracket 36. Power application to the stator coil 34 generates electromagnetic force between the stator coil 34 and the rotor magnet 35, which rotates the rotor magnet 35, the disk hub 33, and the shaft member 2 all together.

### BRIEF DESCRIPTION OF THE DRAWINGS

FIG. 1 is an enlarged cross-sectional view illustrating major parts of one example of the injection molding apparatus used in the present invention;

FIG. 2 is an enlarged cross-sectional view illustrating major parts of one process step of injection molding;

FIG. 3 is a diagram illustrating one example of a radial dynamic pressure generating groove forming part;

FIG. 4 is a cross-sectional view illustrating one example of a fluid dynamic bearing device incorporating a bearing member having the dynamic pressure generating grooves formed by the method of the present invention;

FIG. 5A is a longitudinal cross-sectional view of the bearing member;

FIG. 5B is a diagram illustrating one end face of the bearing member;

FIG. 6 is a cross-sectional view illustrating one example of a shaft member formed by the method of the present invention;

FIG. 7 is a cross-sectional view illustrating one example of a fluid dynamic bearing device incorporating a rotating member formed by the method of the present invention; and

FIG. 8 is a cross-sectional view illustrating one example of a spindle motor for use in information equipment, in which the fluid dynamic bearing device shown in FIG. 4 is mounted.

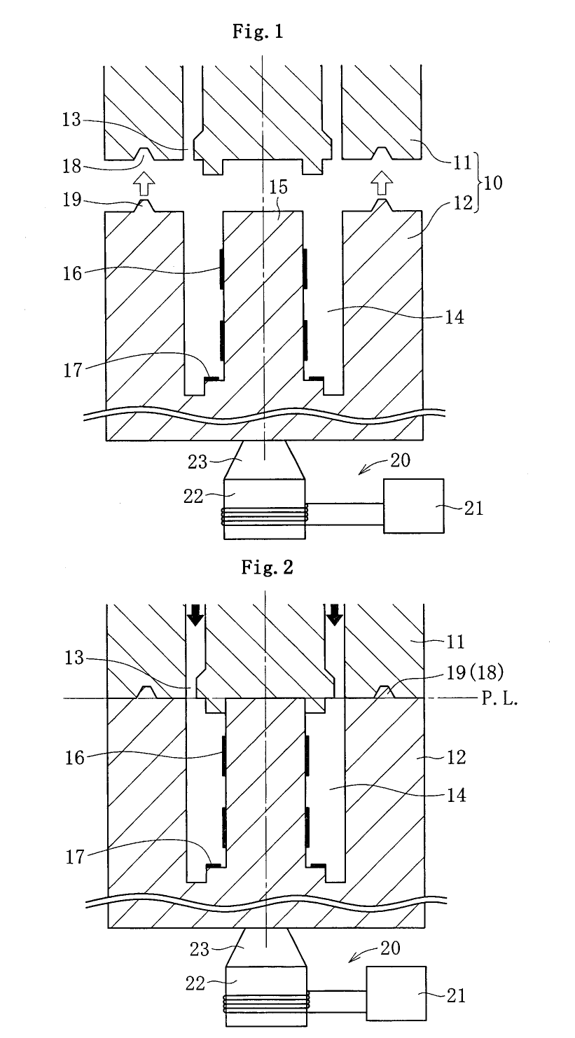

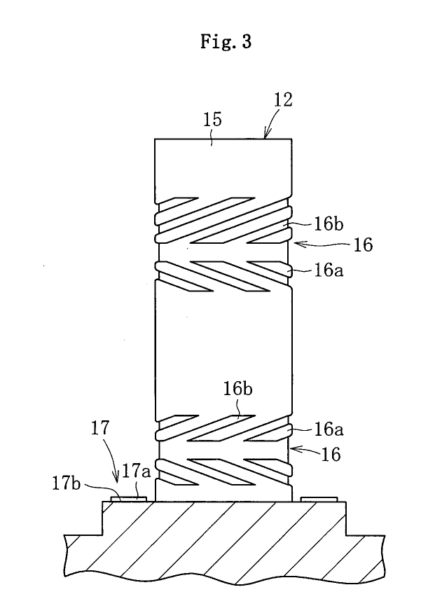

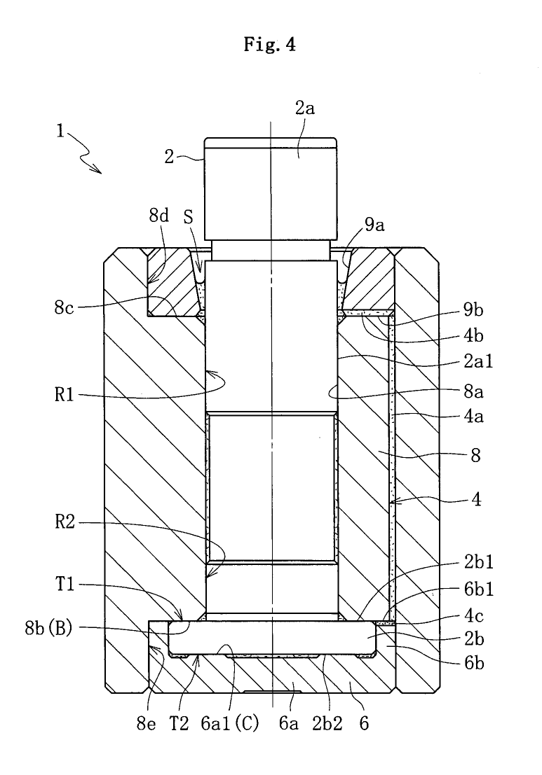

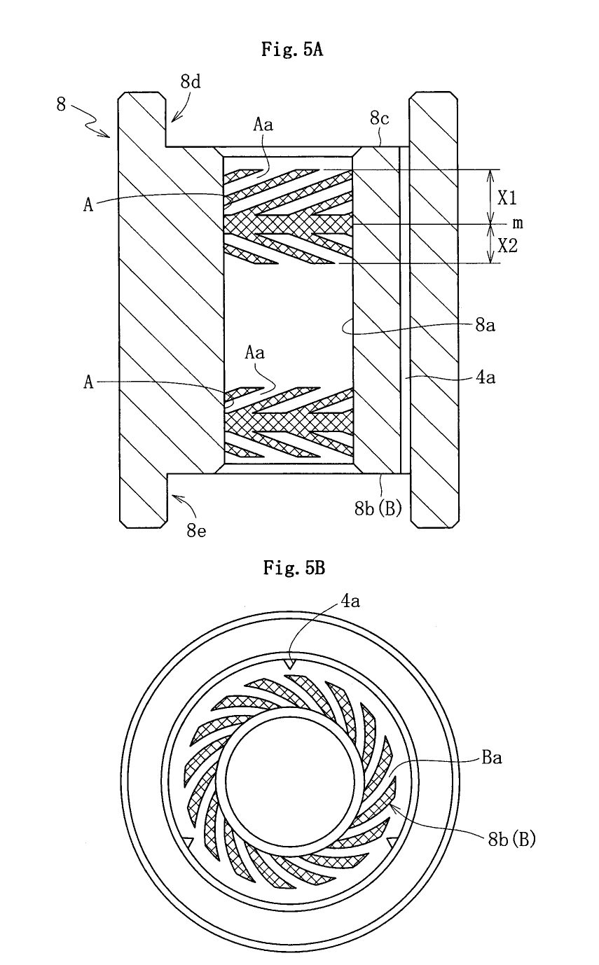

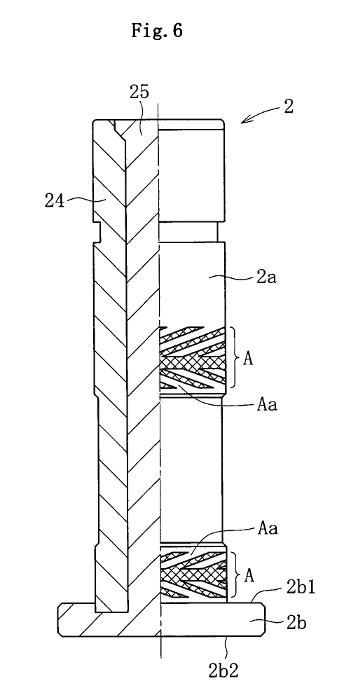

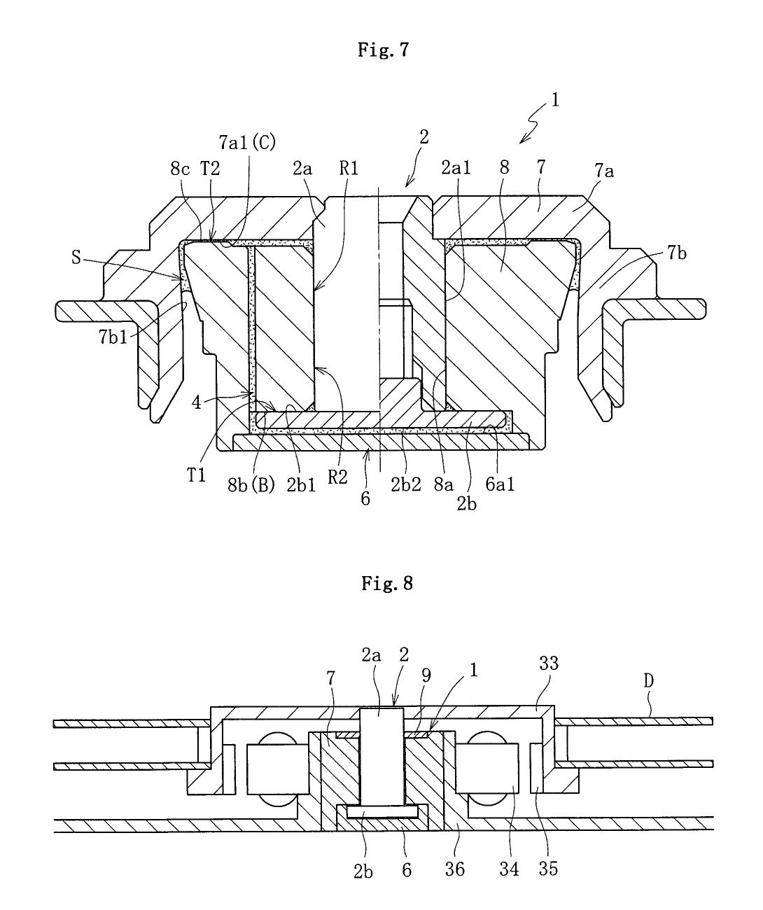

1. A method for forming dynamic pressure generating grooves characterized in that ultrasonic vibration is applied to an injection mold when dynamic pressure generating grooves are molded using dynamic pressure generating groove forming parts provided in the injection mold.

2. A method for forming dynamic pressure generating grooves characterized in that ultrasonic vibration is applied to the injection mold when a molded piece is released from the injection mold after the dynamic pressure generating grooves have been molded by the dynamic pressure generating groove forming part provided in the injection mold.

3. The method for forming dynamic pressure generating grooves according to claim 1, wherein the injection mold is one for forming a fixed member having one surface that faces a bearing gap.

4. The method for forming dynamic pressure generating grooves according to claim 2, wherein the injection mold is one for forming a fixed member having one surface that faces a bearing gap.

5. The method for forming dynamic pressure generating grooves according to claim 1, wherein the injection mold is one for forming a rotating member having the other surface that faces a bearing gap.

6. The method for forming dynamic pressure generating grooves according to claim 2, wherein the injection mold is one for forming a rotating member having the other surface that faces a bearing gap.
